(19) United States
(12) Patent Application Publication
(10) Pub. No.: US 2025/0376088 A1
(43) Pub. Date: Dec. 11, 2025

(54) SEAT

(71) Applicant: TOYOTA BOSHOKU KABUSHIKI KAISHA, Aichi (JP)

(72) Inventor: Kosuke TANIGUCHI, Nagoya-shi (JP)

(73) Assignee: TOYOTA BOSHOKU KABUSHIKI KAISHA, Aichi (JP)

(21) Appl. No.: 19/225,337

(22) Filed: Jun. 2, 2025

(30) Foreign Application Priority Data
Jun. 7, 2024 (JP) 2024-092995

(51) Int. Cl. B60N 2/18; B60N 2/12

(52) U.S. Cl. CPC B60N 2/1867; B60N 2/181; B60N 2/1835; B60N 2/1842; B60N 2/1892; B60N 2/12

(57) ABSTRACT

Provided is a seat having improved rigidity. The seat includes: a first side frame; a second side frame, a connection body; a base member; a first drive-side link; a second drive-side link, an actuator that generates a force for changing an angle between the first drive-side link and the second drive-side link; a first driven-side link that is fixed on the second side frame side of the connection body and rotates integrally with the connection body; a second driven-side link whose first end side is rotatably connected to a second end side of the first driven-side link and whose second end side is rotatably connected to a base member; and a transmission mechanism that mechanically transmits, when a force for rotating the second driven-side link about a connection part between the second driven-side link and the base member acts on the second driven-side link, the force to the connection body.

### CROSS-REFERENCE TO RELATED APPLICATIONS

This application claims the benefit of Japanese Patent Application No. 2024-092995 filed with the Japanese Patent Office on Jun. 7, 2024, the entire disclosure of which is incorporated herein by reference.

### BACKGROUND

The present disclosure relates to a seat in which a posture of a seat cushion can be changed.

For example, Chinese Patent No. 113968176A discloses, as a seat capable of changing a posture of the seat cushion, a car seat including: two links each provided on one of the left and right sides of the front end side of the seat cushion; two connection pipes extending in the left-and-right direction and connecting the links; and the like.

### SUMMARY

One aspect of the present disclosure is to improve rigidity of a seat.

One aspect of the present disclosure is a seat. The seat is configured such that a seat cushion is displaceable between the following postures: a comfortable posture in which a front end side of the seat cushion is higher than a rear end side of the seat cushion; and a normal posture in which a height difference between the front end side and the rear end side is small compared to the comfortable posture. It is desirable that the seat includes, for example, at least one of the following components.

That is, the components are as follows:
a first side frame that constitutes a part of a cushion frame, the first side frame being disposed on a first end side in a seat width direction and extending in a seat front-rear direction;
a second side frame that constitutes a part of the cushion frame, the second side frame being disposed on a second end side in the seat width direction and extending in the seat front-rear direction;
a connection body extending in the seat width direction and rotatably connected to each of a front end side of the first side frame and a front end side of the second side frame, the connection body constituting a part of the cushion frame and having a rotation center axis line parallel to the seat width direction; and
a base member directly or indirectly connected rotatably to a rear end side of the cushion frame; and
a first drive-side link having a first end side fixed on the first side frame side of the connection body, the first drive-side link being configured to rotate integrally with the connection body; and
a second drive-side link having: a first end side rotatably connected to a second end side of the first drive-side link; and a second end side rotatably connected to the base member, wherein a rotation center axis line of a connection part between the first end side of the second drive-side link and the second end side of the first drive-side link and a rotation center axis line of a connection part between the second end side of the second drive-side link and the base member are parallel to the seat width direction;
an actuator that generates a force for changing an angle between the first drive-side link and the second drive-side link, the actuator being configured to change a posture of the seat cushion between the comfortable posture and the normal posture; and
a first driven-side link having a first end side fixed on the second side frame side of the connection body, the first driven-side link being configured to rotate integrally with the connection body;
a second driven-side link having: a first end side rotatably connected to a second end side of the first driven-side link; and a second end side rotatably connected to the base member, wherein a rotation center axis line of a connection part between the first end side of the second driven-side link and the second end side of the first driven-side link and a rotation center axis line of a connection part between the second end side of the second driven-side link and the base member are parallel to the seat width direction; and
a transmission mechanism that mechanically transmits, when a force for rotating the second driven-side link about a connection part between the second driven-side link and the base member acts on the second driven-side link, the force to the connection body.

As a result, in the seat, rotation of the connection body is restricted by the actuator in a state where the actuator is stationary. If an external force is input to the seat and a rotational force for rotating the second driven-side link is thereby generated, the rotational force is transmitted to the connection body via the transmission mechanism.

At this time, since the rotation of the connection body is restricted, a reaction force that cancels the rotational force is transmitted from the connection body to the second driven-side link via the transmission mechanism. Therefore, since such a configuration restricts the rotation of the second driven-side link, the rigidity of the seat is improved.

The seat may have, for example, the following configuration.

That is, the transmission mechanism includes:
a sun gear that is rotatable integrally with the connection body;
a planetary gear that has a rotation center revolvable about a center of the sun gear and rotates while meshing with the sun gear;
a planetary carrier that rotatably supports the planetary gear and is capable of restricting revolution of the planetary gear; and
an internal gear that meshes with the planetary gear and is displaceable integrally with the second driven-side link,
wherein the planetary carrier restricts the revolution of the planetary gear when the actuator is stopped, and allows the revolution of the planetary gear when the actuator is operated.

The following configuration is desirable. The sun gear is displaceable integrally with the first driven-side link in a state where the center of the sun gear coincides with a connection center between the first driven-side link and the second driven-side link, and
the internal gear is displaceable integrally with the second driven-side link about a connection part between the second driven-side link and the base member.

The planetary gear is desirably configured as follows. The planetary gear includes:
a small gear part that meshes with the sun gear; and
a large gear part that meshes with the internal gear and has a larger number of teeth than the small gear part, the large gear part being disposed coaxially with the small gear part and integrated with the small gear part.

The following configuration is desirable. When a center of the connection part between the second driven-side link and the base member is defined as a pivot center, and an imaginary line segment connecting the pivot center and a center of the connection body is defined as an imaginary link line, and an imaginary line passing through a midpoint of the imaginary link line and a revolution center of the planetary gear is defined as a restriction line, the planetary carrier is provided with an elongated hole whose long diameter direction coincides with the restriction line,
the seat further comprising:
a restriction pin that is fitted in the elongated hole and is displaceable in the long diameter direction in the elongated hole;
a first restriction link having: a first end side rotatably connected to the base member; and a second end side to which the restriction pin is connected; the first restriction link having a rotation center disposed coaxially with a connection center between the second driven-side link and the base member; and
a second restriction link having: a first end side rotatably connected to the connection body; a rotation center disposed on a center axis line of the connection body; and a second end side directly or indirectly connected to the restriction pin,
wherein, when the actuator is stopped, the revolution of the planetary gear is restricted by the elongated hole, the restriction pin, the first restriction link, and the second restriction link, and when the actuator is operated, the revolution of the planetary gear is allowed.

The following configuration is desirable. The seat includes:
a “second small gear part”, a “second planetary carrier”, a “second restriction pin”, a “second first restriction link”, a “second sun gear”, and a “second first driven-side link” that are provided on a side opposite to the small gear part across the large gear part,
wherein the “second sun gear” is provided on the “second first driven-side link”,
the “second sun gear” meshes with the “second small gear part”,
the “second restriction pin” is provided on the “second first restriction link” and displaceably fitted in a “second elongated hole” provided in the “second planetary carrier”, and
the “second restriction pin” is disposed coaxially with the restriction pin.

With such a configuration, necessary strength can be secured.

The transmission mechanism may be configured as follows. The transmission mechanism uses a planetary gear mechanism, and
the seat includes:
an internal gear rotatable integrally with the connection body;
a planetary gear that has a rotation center revolvable about a center of the sun gear and rotates while meshing with the sun gear;
a planetary carrier that rotatably supports the planetary gear and is capable of restricting revolution of the planetary gear; and
a sun gear that meshes with the planetary gear and is displaceable integrally with the second driven-side link,
wherein the planetary carrier restricts the revolution of the planetary gear when the actuator is stopped, and allows the revolution of the planetary gear when the actuator is operated.

### BRIEF DESCRIPTION OF THE DRAWINGS

An example embodiment of the present disclosure will be described below with reference to the accompanying drawings, in which:

FIG. 1 is a diagram illustrating a cushion frame according to a first embodiment;

FIG. 2 is a diagram illustrating the cushion frame according to the first embodiment;

FIG. 3 is a diagram illustrating the cushion frame according to the first embodiment;

FIG. 4 is a diagram illustrating the cushion frame according to the first embodiment;

FIG. 5 is a diagram illustrating the cushion frame according to the first embodiment;

FIG. 6 is a diagram illustrating a posture change mechanism according to the first embodiment;

FIG. 7 is a diagram illustrating a drive-side change mechanism according to the first embodiment;

FIG. 8 is a diagram illustrating a driven-side change mechanism according to the first embodiment;

FIG. 9 is a diagram illustrating the driven-side change mechanism according to the first embodiment;

FIG. 10 is a diagram illustrating the driven-side change mechanism according to the first embodiment;

FIG. 11 is a diagram illustrating the driven-side change mechanism according to the first embodiment;

FIG. 12 is a diagram illustrating the driven-side change mechanism according to the first embodiment;

FIG. 13 is a diagram illustrating the driven-side change mechanism according to the first embodiment;

FIG. 14 is a diagram illustrating the driven-side change mechanism according to the first embodiment;

FIG. 15 is a diagram illustrating the driven-side change mechanism according to the first embodiment; and

FIG. 16 is a diagram illustrating a driven-side change mechanism according to a second embodiment.

### DETAILED DESCRIPTION OF EXEMPLARY EMBODIMENTS

The following “embodiment of the invention” describes an example of an embodiment belonging to the technical scope of the present disclosure. That is, the matters specifying the invention and the like described in the claims are not limited to the specific configurations, structures or the like described in the following embodiments.

The present embodiment is an example in which the seat according to the present disclosure is applied to a seat (hereinafter, referred to as a vehicle seat) to be mounted on a vehicle such as a car. Arrows indicating directions, oblique lines, and the like attached to the drawings are described in order to facilitate understanding of the relationship between the drawings, the shapes of members or parts, and the like.

Therefore, the vehicle seat is not limited by the directions illustrated in the drawings. The directions illustrated in the drawings are directions in a state where the vehicle seat according to the present embodiment is assembled to a car. A diagram attached with oblique lines does not always indicate a cross-sectional view.

Regarding a member or part described with at least a reference numeral, at least one member or one part is provided unless there is a note, for example “one”. The seat described in the present disclosure includes at least one of constituent components such as members or parts described with reference numerals and structural parts illustrated in the drawings.

### First Embodiment

### 1. Outline of Vehicle Seat

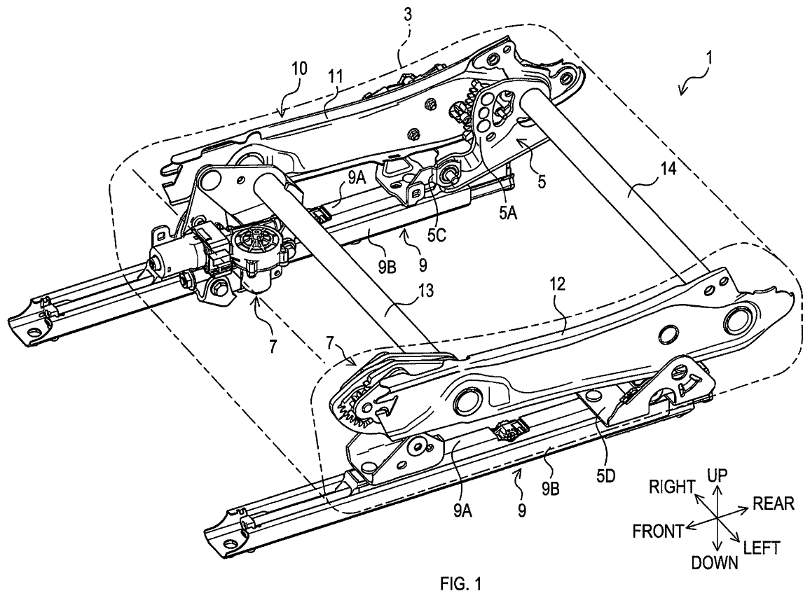

As illustrated in FIG. 1, a vehicle seat 1 includes at least a seat cushion 3, a seat back (not illustrated), a posture change mechanism 7, and the like. The seat cushion 3 is a part for supporting the buttocks of a seated person.

The seat back is a part for supporting the back of the seated person. The seat back is connected to a rear end side of the seat cushion 3. In addition, an angle of the seat back with respect to the seat cushion 3 can be changed.

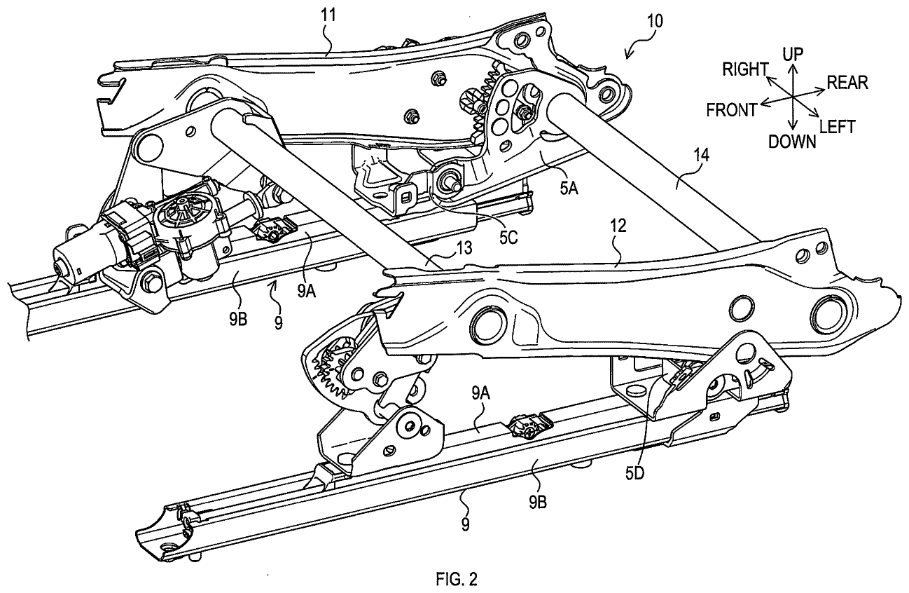

The posture change mechanism 7 is a mechanism for displacing a posture of the seat cushion 3 between a comfortable posture and a normal posture. As illustrated in FIG. 2, the comfortable posture is a posture in which a front end side of the seat cushion 3 is higher than the rear end side of the seat cushion 3.

As illustrated in FIG. 1, the normal posture is a posture in which a height difference between a position of the front end side of the seat cushion 3 and a position of the rear end side of the seat cushion 3 is smaller than in the comfortable posture. That is, the normal posture is mainly a posture for a driver of a car to drive the car.

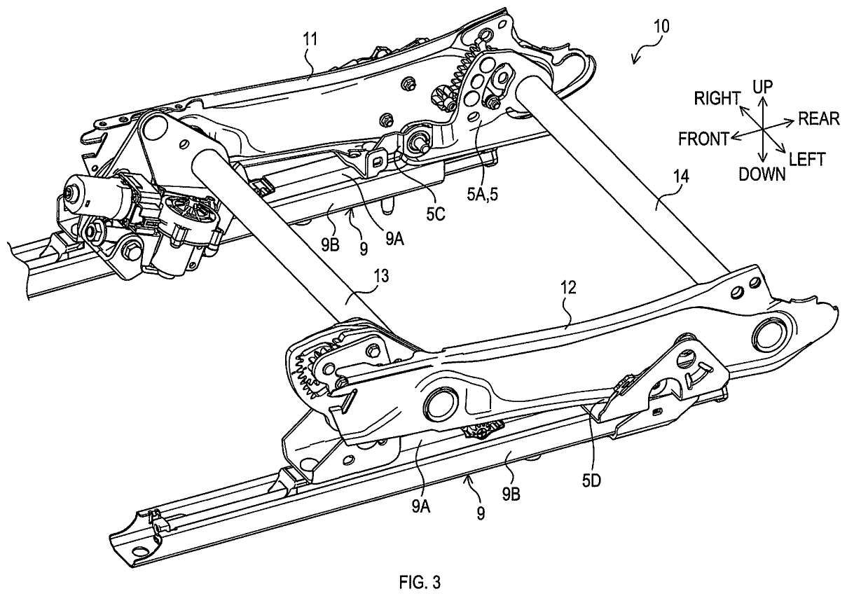

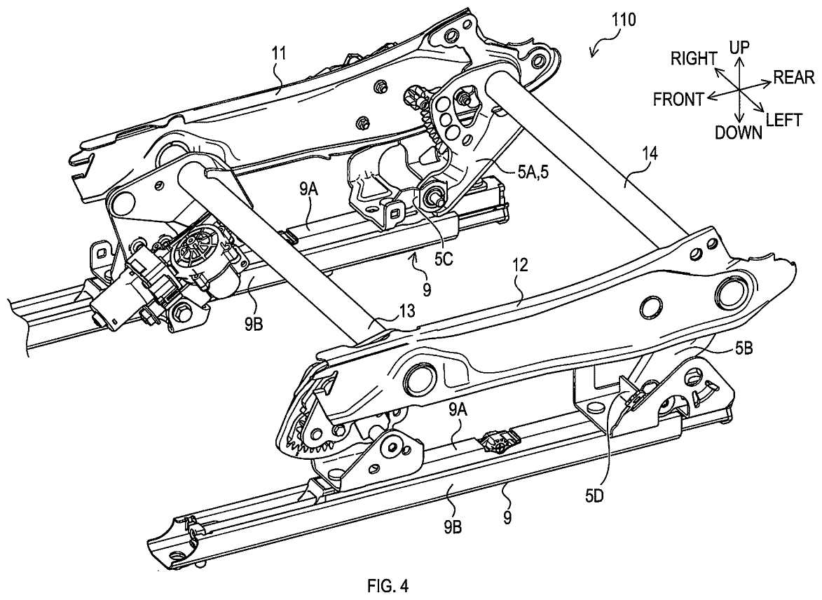

The vehicle seat 1 according to the present embodiment also includes a lifter mechanism 5. The lifter mechanism 5 vertically displaces the seat cushion 3 in the normal posture state. Note that FIG. 3 illustrates a state in which the seat cushion 3 is at the lowest position. FIG. 4 illustrates a state in which the seat cushion 3 is at the highest position.

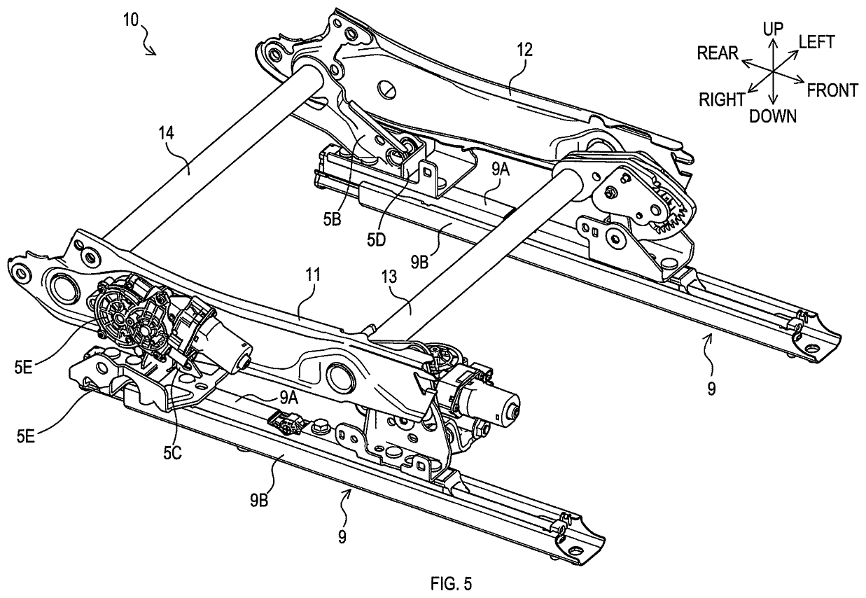

The seat cushion 3 is connected to a slide device 9 via lifter links 5A (see FIG. 1) and 5B (see FIG. 5) constituting the lifter mechanism 5 and via the posture change mechanism 7. Note that when the lifter mechanism 5 is operated, the posture change mechanism 7 functions as a lifter link of the lifter mechanism 5.

The slide device 9 is configured to displace the seat cushion 3 in a front-rear direction. The slide device 9 includes at least movable rails 9A, fixed rails 9B, and the like. The fixed rails 9B are rail members fixed to the vehicle. The movable rails 9A are an example of a base member and are slidably connected to the fixed rails 9B.

### 2. Configuration and the Like of Cushion Frame and Posture Change Mechanism

### 2.1 Configuration of Cushion Frame

The cushion frame is a reinforcing member constituting a framework of the seat cushion 3. As illustrated in FIG. 1, a cushion frame 10 includes at least a first side frame 11, a second side frame 12, a first connection pipe 13, a second connection pipe 14, and the like.

The first side frame 11 is a lower arm disposed on a first end side in a seat width direction and extending in the seat front-rear direction. The second side frame 12 is a lower arm disposed on a second end side in the seat width direction and extending in the seat front-rear direction.

The first connection pipe 13 is an example of a connection body, extends in the seat width direction, connects a front end side of the first side frame 11 and a front end side of the second side frame 12, and is rotatably connected to the side frames 11 and 12.

The second connection pipe 14 extends in the seat width direction and is rotatably connected to each of a rear end side of the first side frame 11 and a rear end side of the second side frame 12. Upper end sides of the lifter links 5A and 5B are integrated with the second connection pipe 14.

Lower end sides of the lifter links 5A and 5B are rotatably connected to the corresponding movable rails 9A via brackets 5C and 5D. In other words, a rear end side of the cushion frame 10 is indirectly and rotatably connected to the movable rails 9A via the lifter links 5A and 5B.

The first side frame 11 or the second side frame 12 (the first side frame 11, in the present embodiment) is provided with an actuator 5E (see FIG. 5). The actuator 5E exerts a driving force for rotating the second connection pipe 14.

As a result, when the actuator 5E is operated to rotate the second connection pipe 14, the lifter links 5A and 5B are rotationally displaced with respect to the cushion frame 10, so that the cushion frame 10 is vertically displaced in conjunction with the rotational displacement.

### 2.2 Configuration of Posture Change Mechanism

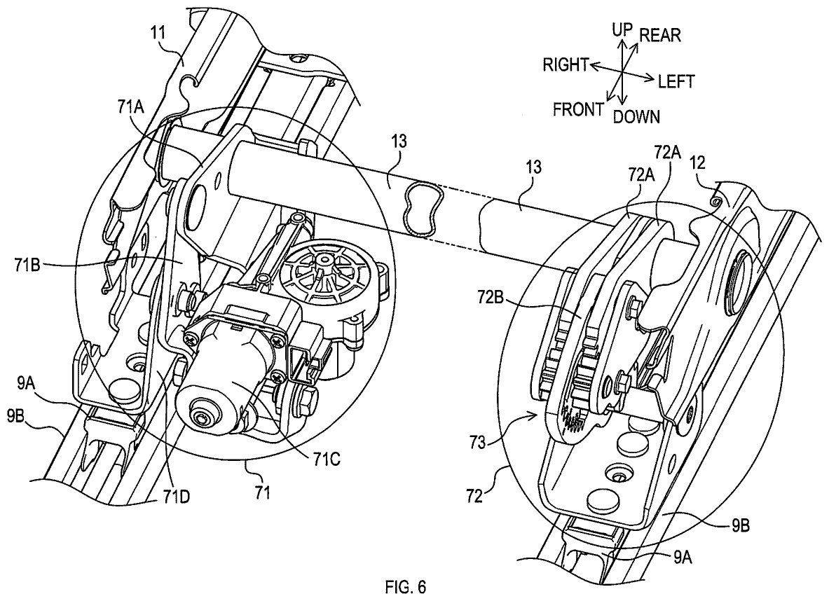

As illustrated in FIG. 6, the posture change mechanism 7 includes a drive-side change mechanism 71, a driven-side change mechanism 72, and the like. The drive-side change mechanism 71 exerts a driving force for changing the posture of the seat cushion 3. The driven-side change mechanism 72 receives the driving force from the drive-side change mechanism 71 and changes the posture of the seat cushion 3 in cooperation with the drive-side change mechanism 71.

### 2.3 Configuration of Drive-Side Change Mechanism

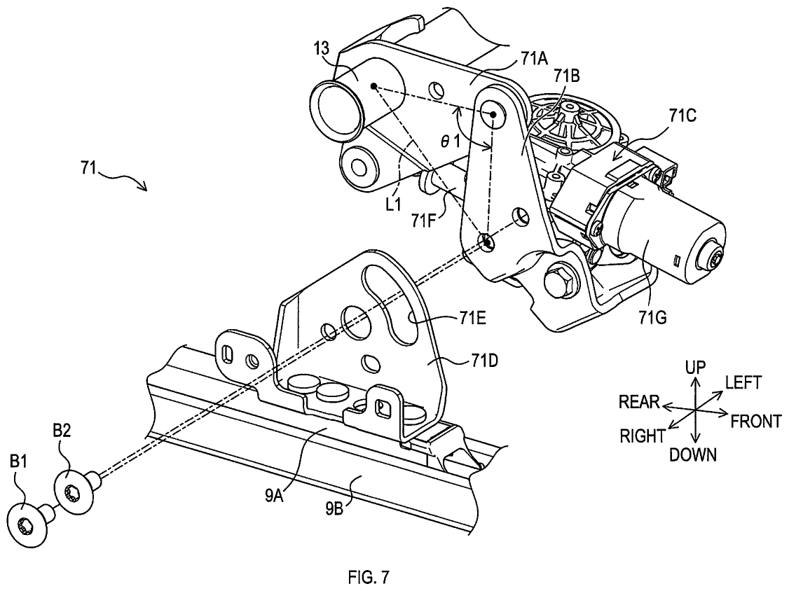

As illustrated in FIG. 7, the drive-side change mechanism 71 includes at least a first drive-side link 71A, a second drive-side link 71B, an actuator 71C, and the like. As illustrated in FIG. 6, the first drive-side link 71A is a member a first end side of which is fixed on the first side frame 11 side of the first connection pipe 13 and that rotates integrally with the first connection pipe 13.

The second drive-side link 71B is a member a first end side of which is rotatably connected to a second end side of the first drive-side link 71A and a second end side of which is rotatably connected to the movable rail 9A via a bracket 71D, and rotation center axis lines of the connection parts of those members are parallel to the seat width direction.

As illustrated in FIG. 7, the bracket 71D is provided with an arc-shaped elongated hole 71E that guides rotation of the second drive-side link 71B. A bolt B1 connects the second drive-side link 71B and the bracket 71D in a rotatable manner. A bolt B2 passes through the elongated hole 71E and is fixed to the second drive-side link 71B.

The actuator 71C generates a force for changing an angle θ1 between the first drive-side link 71A and the second drive-side link 71B. Specifically, the actuator 71C includes a male threaded rod 71F, an electric motor 71G, and the like.

A first end side of the male threaded rod 71F in the longitudinal direction is rotatably connected to the first drive-side link 71A. The electric motor 71G rotates a nut (not illustrated) screwed to the male threaded rod 71F via a speed reducer (not illustrated) having a worm and a worm wheel.

Therefore, when the nut rotates, the male threaded rod 71F is displaced in the longitudinal direction of the male threaded rod 71F such that the male threaded rod 71F expands and contracts with respect to the electric motor 71G. The electric motor 71G is connected to the second drive-side link 71B in a rotatably displaceable manner.

Since the actuator 71C includes the electric motor 71G and the speed reducer, it is practically impossible to rotate the electric motor 71G by applying a rotational force to an output shaft of the speed reducer from outside. Hereinafter, this function is referred to as a “self-lock function”.

As a result, when the male threaded rod 71F is displaced in the longitudinal direction of the male threaded rod 71F, the angle θ1 is increased or decreased in conjunction with the displacement, and a length of L1 is thereby changed, so that the posture of the seat cushion 3 is changed between the comfortable posture and the normal posture.

The length of L1 is the distance between a center axis line, of the first connection pipe 13, projected on a virtual plane orthogonal to the seat width direction and the connection center axis line, of the second drive-side link 71B and the movable rail 9A, projected on the virtual plane.

When the lifter mechanism 5 is operated, that is, when the actuator 5E is operated, the actuator 71C is stopped in principle. Therefore, when the lifter mechanism 5 is operated, the length of L1 does not change. That is, the length of L1 corresponds to the length of the lifter links of the lifter mechanism 5.

### 2.4 Configuration of Driven-Side Change Mechanism

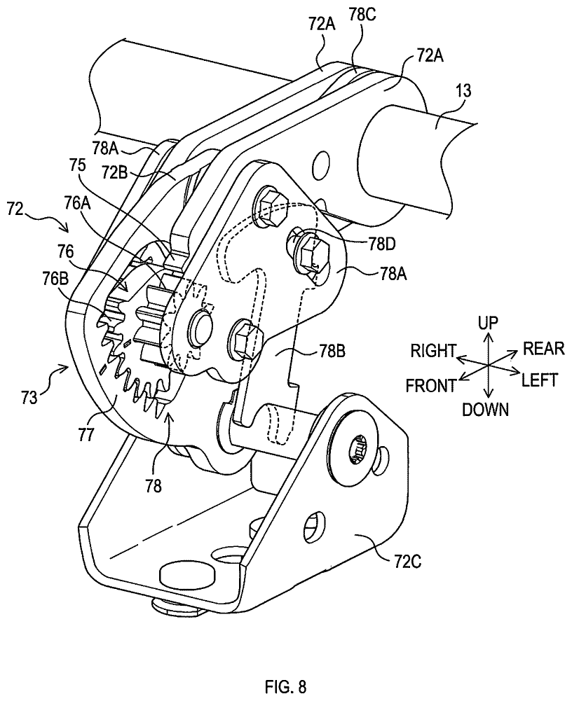

As illustrated in FIG. 8, the driven-side change mechanism 72 includes at least first driven-side links 72A, a second driven-side link 72B, a transmission mechanism 73, and the like. The driven-side change mechanism 72 according to the present embodiment has a symmetrical configuration across the second driven-side link 72B.

Therefore, on each of one side and the other side across the second driven-side link 72B, there are provided the first driven-side link 72A, a planetary carrier (78A) to be described later, and the like. Note that the same configuration is provided on each of one side and the other side across the second driven-side link 72B.

The following is a description of the configuration of the driven-side change mechanism 72 regarding one side (the left side, in FIG. 8) of the second driven-side link 72B. Therefore, unless otherwise specified, the configuration on the other side (the right side, in FIG. 8) of the second driven-side link 72B is the same as on the one side (the left side, in FIG. 8).

As illustrated in FIG. 6, a first end side of the first driven-side link 72A is fixed on the second side frame 12 side of the first connection pipe 13. Therefore, the first driven-side link 72A rotates integrally with the first connection pipe 13.

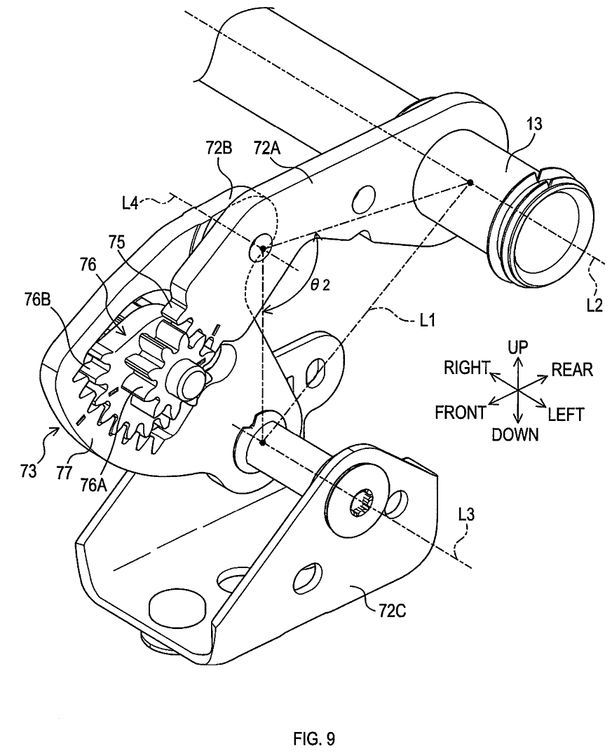

As illustrated in FIG. 9, a first end side of the second driven-side link 72B is rotatably connected to a second end side of the first driven-side link 72A, and a second end side of the second driven-side link 72B is rotatably connected to the movable rail 9A via a bracket 72C. The rotation center axis line L2 to L4 of the connection parts of those members are parallel to the seat width direction.

The transmission mechanism 73 is a mechanism that mechanically transmits, when a force for rotating the second driven-side link 72B about the center axis line L3 acts on the second driven-side link 72B, the force to the first connection pipe 13 acts a force.

### 2.5 Detailed Configuration of Transmission Mechanism

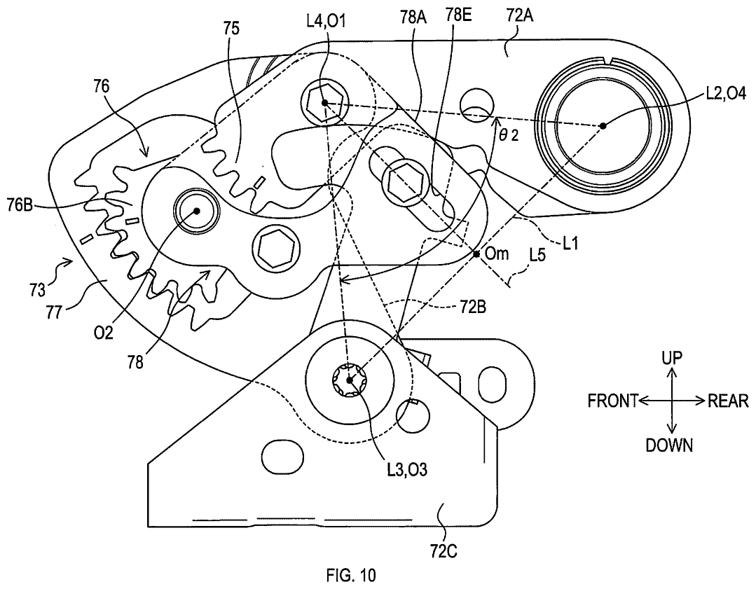

As illustrated in FIG. 10, the transmission mechanism 73 according to the present embodiment is a mechanism that transmits the rotational force using a planetary gear mechanism. Specifically, the transmission mechanism 73 includes a sun gear 75, a planetary gear 76, an internal gear 77, a carrier mechanism 78, and the like.

### <Sun Gear>

The sun gear 75 is a gear integrally rotatable with the first connection pipe 13. Note that the sun gear 75 according to the present embodiment is configured with a sector gear in which a tooth part is provided only in a part of the circumference.

The sun gear 75 is rotationally displaceable together with the first connection pipe 13 integrally with the first driven-side link 72A in a state where a center O1 of the sun gear 75 coincides with a connection center L4 of the first driven-side link 72A and the second driven-side link 72B. That is, the center O1 of the sun gear 75 turns about the first connection pipe 13.

### <Planetary Gear>

The planetary gear 76 is a gear in which a rotation center O2 of the planetary gear 76 is revolvable about the center O1 of the sun gear 75, and is a gear that rotates in mesh with the sun gear 75 and the internal gear 77. The revolution means the rotation about the center O1 of the sun gear 75.

The spin refers to rotation about its own rotation center (the rotation center O2 of the planetary gear 76, in the case of the planetary gear 76). When the angle θ2 between the first driven-side link 72A and the second driven-side link 72B changes, the sun gear 75 spins accordingly about the center O1.

### <Internal Gear>

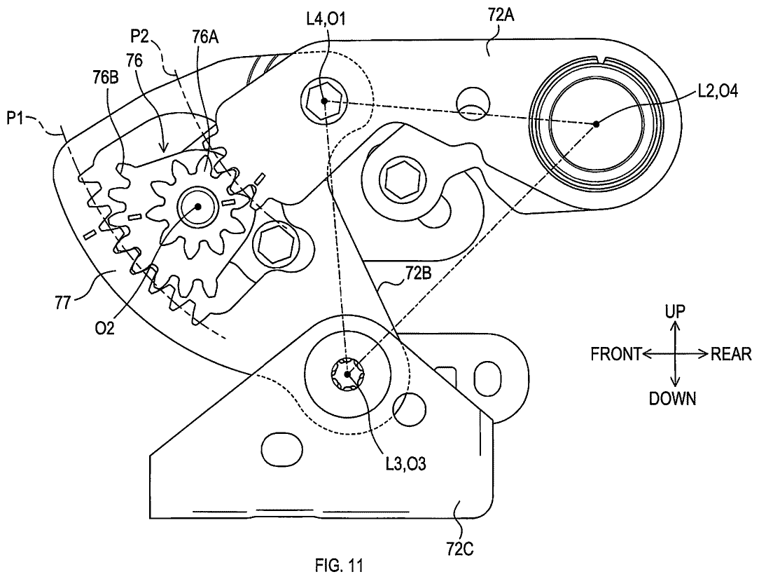

As illustrated in FIG. 11, the internal gear 77 is a gear that meshes with the planetary gear 76. The internal gear 77 is integrated with the second driven-side link 72B and is displaceable integrally with the second driven-side link 72B.

As illustrated in FIG. 9, the planetary gear 76 is configured with a gear in which a small gear part 76A and a large gear part 76B are coaxially disposed and integrated. The small gear part 76A is a gear that meshes with the sun gear 75.

The large gear part 76B is a gear that meshes with the internal gear 77 and has a larger number of teeth than the small gear part 76A. Due to this configuration, in the present embodiment, the difference between a peripheral speed of the internal gear 77 and a peripheral speed of the sun gear 75 is absorbed.

That is, as illustrated in FIG. 11, a pitch circle P1 of the internal gear 77 and a pitch circle P2 of the sun gear 75 draw arcs each centered on the center O1. However, the radius of the pitch circle P1 of the internal gear 77 is different from the radius of the pitch circle P2 of the sun gear 75.

Therefore, in the present embodiment, a peripheral speed difference caused by the difference between the radius of the pitch circle P1 of the internal gear 77 and the radius of the pitch circle P2 of the sun gear 75 is absorbed by the difference between the number of teeth of the small gear part 76A and the number of teeth of the large gear part 76B. Note that the above “number of teeth” is the number of teeth in a case where the tooth part is provided on the entire circumference (360 degrees).

### <Carrier Mechanism>

The carrier mechanism 78 is a mechanism that supports the planetary gear 76 in a spinnable manner and can restrict revolution of the planetary gear 76. The carrier mechanism 78 restricts the revolution of the planetary gear 76 when the actuator 71C is stopped, and allows the revolution of the planetary gear 76 when the actuator 71C is operated.

Specifically, as illustrated in FIG. 8, the carrier mechanism 78 includes at least carrier plates 78A, a first restriction link 78B, a second restriction link 78C, a restriction pin 78D, and the like.

As illustrated in FIG. 8, the carrier plates 78A are members that support the planetary gear 76 in a spinnable manner and can restrict revolution of the planetary gear 76. The carrier plates 78A are supported by the first driven-side link 72A so as to be spinnable about the revolution center O1 (the center of the sun gear 75).

As illustrated in FIG. 10, the carrier plate 78A is provided with an elongated hole 78E whose long diameter direction coincides with a restriction line L5. The restriction line L5 is an imaginary line passing through a midpoint Om of an imaginary link line L1 and the revolution center O1 of the planetary gear 76.

The imaginary link line L1 is an imaginary line segment connecting the connection center axis line L3 (hereinafter, also referred to as a pivot center O3) between the second driven-side link 72B and the bracket 72C and a center O4 of the first connection pipe 13.

Incidentally, in the present embodiment, the length of the imaginary line segment connecting the revolution center O1 and the pivot center O3 is the same as the length of the imaginary line segment connecting the revolution center O1 and the center O4. Therefore, the restriction line L5 according to the present embodiment coincides with a perpendicular bisector of the imaginary link line L1.

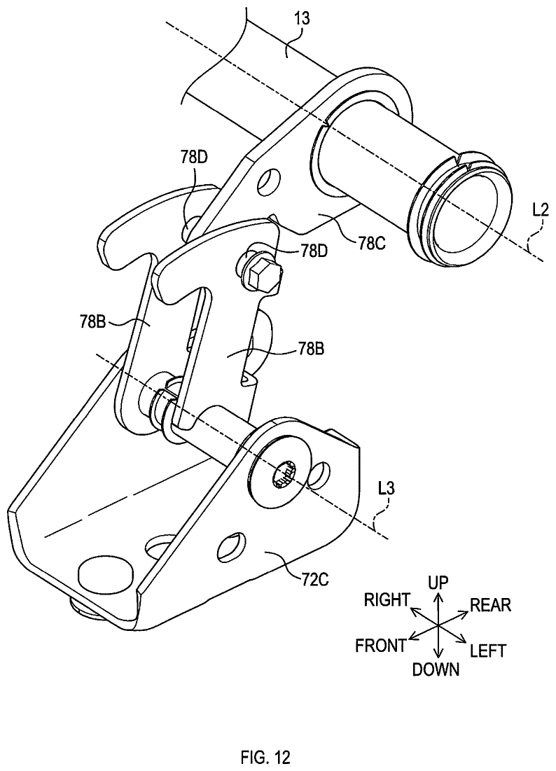

As illustrated in FIG. 12, the first restriction link 78B is a member in which its first end side is rotatably connected to the bracket 72C and the restriction pin 78D is connected to a second end side of the first restriction link 78B. The rotation center on the first end side of the first restriction link 78B is located coaxially with the connection center axis line L3 between the second driven-side link 72B and the bracket 72C.

A first end side of the second restriction link 78C is rotatably connected to the first connection pipe 13, and a rotation center thereof is disposed on the rotation center axis line L2 of the first connection pipe 13. A second end side of the second restriction link 78C is directly or indirectly (directly, in the present embodiment) connected to the restriction pin 78D.

Specifically, the restriction pin 78D penetrates the first restriction link 78B and the second restriction link 78C. At least one restriction link of the first restriction link 78B and the second restriction link 78C is rotatable with respect to the restriction pin 78D.

The restriction pin 78D is a rod-shaped member that is displaceable in the elongated hole 78E in the long diameter direction in the state of being fitted in the elongated hole 78E. The center of the restriction pin 78D is displaced, in the elongated hole 78E, on the restriction line L5 within a range that is on the revolution center O1 side of the imaginary link line L1.

### <Other Configurations>

As described above, the driven-side change mechanism 72 according to the present embodiment has a symmetrical configuration across the second driven-side link 72B.

Specifically, for example, a “second small gear part”, a “second carrier plate”, a “second restriction pin”, a “second first restriction link”, a “second sun gear”, and a “second first driven-side link” are provided on the side opposite to the small gear part 76A across the large gear part 76B illustrated in FIG. 9.

The “second sun gear” is provided on the “second first driven-side link”, and the “second sun gear” meshes with the “second small gear part”. The “second restriction pin” is displaceably fitted in a “second elongated hole” provided in a “second planetary carrier” and is provided in the “second first restriction link”.

The “second restriction pin” is disposed coaxially with the restriction pin 78D. Note that the “second restriction pin” and the restriction pin 78D are constituted by a single one rod-shaped member. Furthermore, the single rod-shaped member extends from the elongated hole 78E of the carrier plate 78A to the “elongated hole of the second carrier plate”.

### 3. Operation of Posture Change Mechanism and Characteristics of Vehicle Seat According to Present Embodiment

The first drive-side link 71A illustrated in FIG. 7 and the first driven-side link 72A illustrated in FIG. 9 rotate integrally with the first connection pipe 13, and the rotation center (hereinafter, referred to as a drive-side pivot) of the second drive-side link 71B and the movable rail 9A and the rotation center of the second driven-side link 72B are located on the same rotation center axis line.

In addition, the first drive-side link 71A is the same as the length of the first driven-side link 72A, and the length of the second drive-side link 71B is the same as the length of the second driven-side link 72B. The length of a link refers to a length between the connection centers or a length between the rotation centers.

Then, as illustrated in FIG. 7, when the actuator 71C is operated to change the angle θ1 between the first drive-side link 71A and the second drive-side link 71B, a relative position of the first connection pipe 13 with respect to the drive-side pivot changes, so that the angle of the first drive-side link 71A with respect to the movable rail 9A changes.

The change in angle of the first drive-side link 71A is mechanically transmitted to the first driven-side link 72A via the first connection pipe 13; therefore, the angle θ2 formed between the first driven-side link 72A and the second driven-side link 72B changes in synchronization with the angle θ1 as illustrated in FIG. 9.

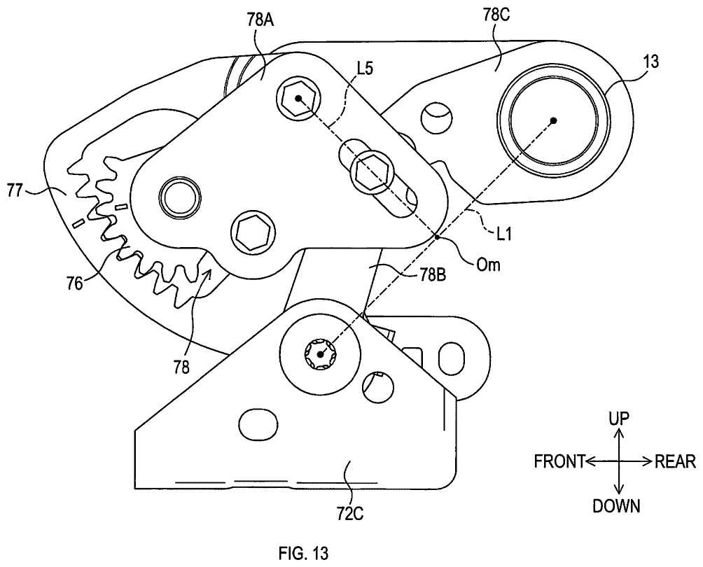

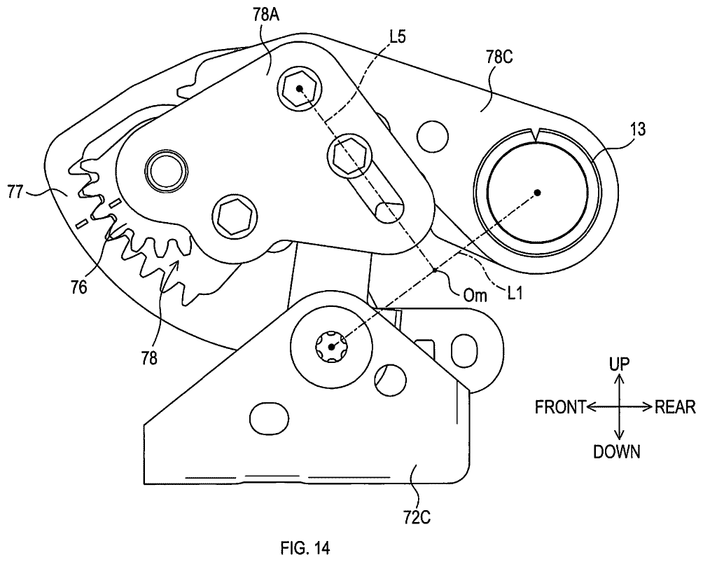

That is, the first driven-side link 72A and the second driven-side link 72B operate such that the angle θ2 and the angle θ1 are always the same (see FIGS. 13 to 15). At this time, the sun gear 75, the planetary gear 76, and the internal gear 77 constituting the transmission mechanism 73 rotate (the planetary gear 76 spins and revolves) in accordance with the change in the angle θ2.

Then, as illustrated in FIGS. 13 to 15, the carrier plate 78A swings (rotates) about the revolution center O1 (the center of the sun gear 75); therefore, the restriction pin 78D is displaced in the elongated hole 78E in the long diameter direction of the elongated hole 78E.

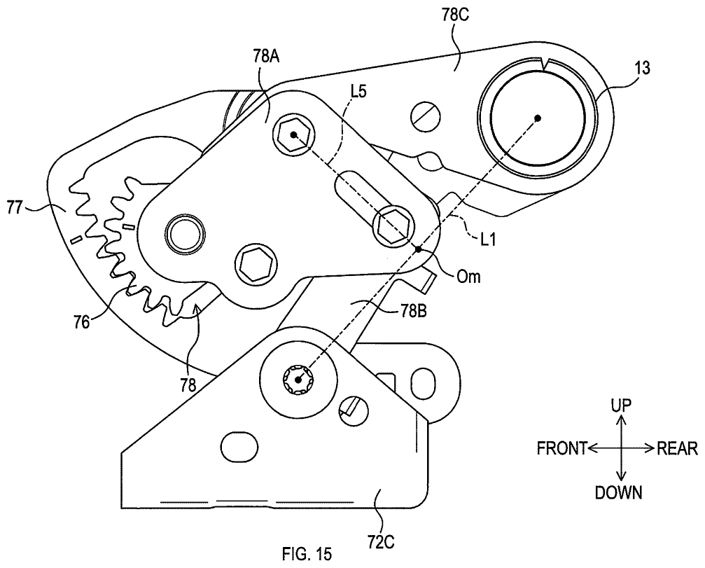

Note that a midpoint Om of the imaginary link line L1 corresponds to a change point (dead point) of the first restriction link 78B and the second restriction link 78C. In addition, even when the restriction pin 78D is closest to the imaginary link line L1, the restriction pin 78D is displaced from the change point (see FIG. 15).

When the actuator 71C is stopped, the angle θ2 stops at the same angle as the angle θ1 at the time the actuator 71C is stopped. At this time, the rotation of the first connection pipe 13 is restricted by the self-lock function of the actuator 71C, the angle θ2 is held at the angle θ1 when the actuator 71C is stopped.

As a result, when the actuator 71C is stopped, the length of the imaginary link line L1 is also held to the length at the time the actuator 71C is stopped; therefore, the displacement of the first restriction link 78B and the second restriction link 78C is restricted, so that the displacement of the restriction pin 78D is also held at the position at the time the actuator 71C is stopped.

That is, when the actuator 71C is stopped, the revolution of the planetary gear 76 is restricted by the elongated hole 78E, the restriction pin 78D, the first restriction link 78B, and the second restriction link 78C, and when the actuator 71C is operated, the revolution of the planetary gear 76 is allowed.

As described above, in the vehicle seat 1, when the actuator 71C is in a stationary state, the rotation of the first connection pipe 13 is restricted by the actuator 71C. If an external force to the vehicle seat 1 is input and a rotational force for rotating the second driven-side link 72B is thereby generated, the rotational force is transmitted to the first connection pipe 13 via the transmission mechanism 73.

At this time, since the rotation is restricted by the self-lock function of the first connection pipe 13, a reaction force that cancels the rotational force is transmitted from the first connection pipe 13 to the second driven-side link 72B via the transmission mechanism 73. Therefore, the rotation of the second driven-side link 72B is restricted, and rigidity of the vehicle seat 1 is improved.

### Second Embodiment

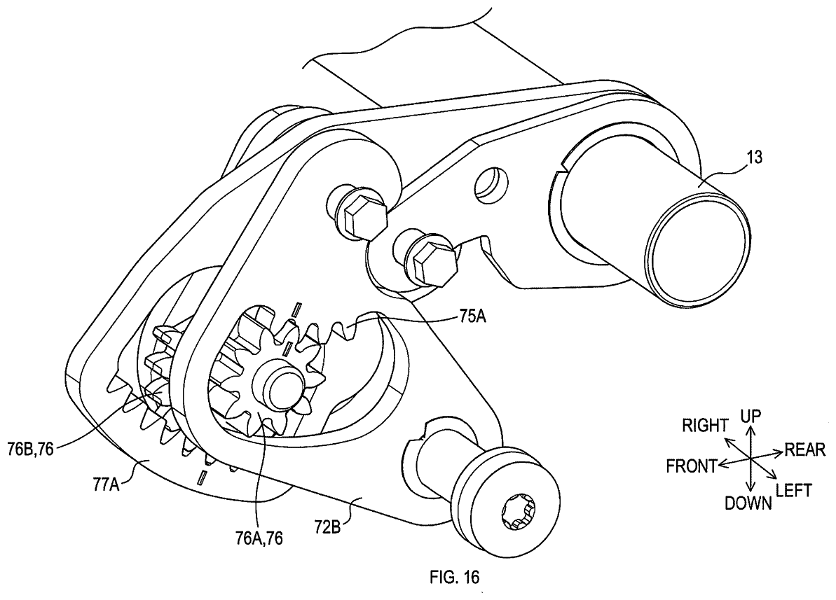

In a transmission mechanism 73 according to the present embodiment, as illustrated in FIG. 16, a sun gear 75A and an internal gear 77A are different from the sun gear 75 and the internal gear 77 according to the first embodiment. That is, the internal gear 77A is configured to be rotatable integrally with a first connection pipe 13.

The sun gear 75A is configured to mesh with a planetary gear 76 and to be displaceable integrally with the second driven-side link 72B. Note that the above description is a description regarding the difference from the above embodiment.

Note that the same components and the like as those in the above-described embodiment are denoted by the same reference numerals as those in the above-described embodiment. Therefore, in the present embodiment, redundant description is omitted. Incidentally, In FIG. 16, a carrier plate 78A and a first restriction link 78B are omitted.

### Other Embodiments

In the above-described embodiment, as illustrated in FIG. 10, the distance from the center axis line L4 to the center axis line L2 is the same as the distance from the center axis line L4 to the center axis line L3. However, the present disclosure is not limited to this configuration. For example, the distance from the center axis line L4 to the center axis line L2 may be different from the distance from the center axis line L4 to the center axis line L3.

The transmission mechanism 73 according to the above-described embodiment is a mechanism using gears. However, the present disclosure is not limited to this configuration. For example, a transmission mechanism 73 using a chain, a toothed belt, or the like may be used.

The above-described embodiment includes the lifter mechanism 5. However, the present disclosure is not limited to this configuration. For example, the lifter mechanism 5 may be eliminated.

In the above-described embodiment, the vehicle seat according to the present disclosure is applied to a car. However, the present invention is not limited thereto. For example, the present invention can also be applied to a seat used for vehicles such as railway cars, ships, and aircrafts, and to a stationary seat used in theaters, homes, and the like.

Furthermore, the present disclosure is not limited to the above-described embodiments as long as the present disclosure meets the gist of the disclosure described in the above-described embodiments. Therefore, a configuration may be such that at least two of the plurality of embodiments described above are combined, or may be such that any of the components illustrated in the drawings or the components described with reference numerals in the embodiments described above is eliminated.

1. A seat comprising:
a seat cushion, the seat being configured to be capable of displacing the seat cushion between a comfortable posture in which a front end side of the seat cushion is higher than a rear end side of the seat cushion and a normal posture in which a height difference between the front end side and the rear end side is smaller than in the comfortable posture;
a first side frame that constitutes a part of a cushion frame, the first side frame being disposed on a first end side in a seat width direction and extending in a seat front-rear direction;
a second side frame that constitutes a part of the cushion frame, the second side frame being disposed on a second end side in the seat width direction and extending in the seat front-rear direction;
a connection body extending in the seat width direction and rotatably connected to each of a front end side of the first side frame and a front end side of the second side frame, the connection body constituting a part of the cushion frame and having a rotation center axis line parallel to the seat width direction; and
a base member directly or indirectly connected rotatably to a rear end side of the cushion frame; and
a first drive-side link having a first end side fixed on the first side frame side of the connection body, the first drive-side link being configured to rotate integrally with the connection body; and
a second drive-side link having: a first end side rotatably connected to a second end side of the first drive-side link; and a second end side rotatably connected to the base member, wherein a rotation center axis line of a connection part between the first end side of the second drive-side link and the second end side of the first drive-side link and a rotation center axis line of a connection part between the second end side of the second drive-side link and the base member are parallel to the seat width direction;
an actuator that generates a force for changing an angle between the first drive-side link and the second drive-side link, the actuator being configured to change a posture of the seat cushion between the comfortable posture and the normal posture; and
a first driven-side link having a first end side fixed on the second side frame side of the connection body, the first driven-side link being configured to rotate integrally with the connection body;
a second driven-side link having: a first end side rotatably connected to a second end side of the first driven-side link; and a second end side rotatably connected to the base member, wherein a rotation center axis line of a connection part between the first end side of the second driven-side link and the second end side of the first driven-side link and a rotation center axis line of a connection part between the second end side of the second driven-side link and the base member are parallel to the seat width direction; and
a transmission mechanism that mechanically transmits, when a force for rotating the second driven-side link about a connection part between the second driven-side link and the base member acts on the second driven-side link, the force to the connection body.

2. The seat according to claim 1, wherein the transmission mechanism includes:
a sun gear that is rotatable integrally with the connection body;
a planetary gear that has a rotation center revolvable about a center of the sun gear and rotates while meshing with the sun gear;
a planetary carrier that rotatably supports the planetary gear and is capable of restricting revolution of the planetary gear; and
an internal gear that meshes with the planetary gear and is displaceable integrally with the second driven-side link,
wherein the planetary carrier restricts the revolution of the planetary gear when the actuator is stopped, and allows the revolution of the planetary gear when the actuator is operated.

3. The seat according to claim 2, wherein the sun gear is displaceable integrally with the first driven-side link in a state where the center of the sun gear coincides with a connection center between the first driven-side link and the second driven-side link, and
the internal gear is displaceable integrally with the second driven-side link about a connection part between the second driven-side link and the base member.

4. The seat according to claim 3, wherein the planetary gear includes:
a small gear part that meshes with the sun gear; and
a large gear part that meshes with the internal gear and has a larger number of teeth than the small gear part, the large gear part being disposed coaxially with the small gear part and integrated with the small gear part.

5. The seat according to claim 4, wherein, when a center of the connection part between the second driven-side link and the base member is defined as a pivot center, and an imaginary line segment connecting the pivot center and a center of the connection body is defined as an imaginary link line, and an imaginary line passing through a midpoint of the imaginary link line and a revolution center of the planetary gear is defined as a restriction line, the planetary carrier is provided with an elongated hole whose long diameter direction coincides with the restriction line,
the seat further comprising:
a restriction pin that is fitted in the elongated hole and is displaceable in the long diameter direction in the elongated hole;
a first restriction link having: a first end side rotatably connected to the base member; and a second end side to which the restriction pin is connected, the first restriction link having a rotation center disposed coaxially with a connection center between the second driven-side link and the base member; and
a second restriction link having: a first end side rotatably connected to the connection body; a rotation center disposed on a center axis line of the connection body; and a second end side directly or indirectly connected to the restriction pin,
wherein, when the actuator is stopped, the revolution of the planetary gear is restricted by the elongated hole, the restriction pin, the first restriction link, and the second restriction link, and when the actuator is operated, the revolution of the planetary gear is allowed.

6. The seat according to claim 5, further comprising:
a second small gear part, a second planetary carrier, a second restriction pin second first restriction link, a second sun gear, and a second first driven-side link that are provided on a side opposite to the small gear part across the large gear part,
wherein the second sun gear is provided on the second first driven-side link,
the second sun gear meshes with the second small gear part,
the second restriction pin is provided on the second first restriction link and displaceably fitted in a second elongated hole provided in the second planetary carrier, and
the second restriction pin is disposed coaxially with the restriction pin.

7. The seat according to claim 1, wherein the transmission mechanism uses a planetary gear mechanism,
the seat comprising:
an internal gear rotatable integrally with the connection body;
a planetary gear that has a rotation center revolvable about a center of the sun gear and rotates while meshing with the sun gear;
a planetary carrier that rotatably supports the planetary gear and is capable of restricting revolution of the planetary gear; and
a sun gear that meshes with the planetary gear and is displaceable integrally with the second driven-side link,
wherein the planetary carrier restricts the revolution of the planetary gear when the actuator is stopped, and allows the revolution of the planetary gear when the actuator is operated.
